(19) United States
(12) Patent Application Publication
(10) Pub. No.: US 2024/0080208 A1
(43) Pub. Date: Mar. 7, 2024

(54) BLOCKCHAIN APPLICATION METHOD AND BLOCKCHAIN APPLICATION TERMINAL APPARATUS

(71) Applicant: Jinqian HU, Hangzhou (CN)

(72) Inventor: Jinqian HU, Hangzhou (CN)

(21) Appl. No.: 18/503,954

(22) Filed: Nov. 7, 2023

Related U.S. Application Data
(63) Continuation of application No. PCT/CN2022/090239, filed on Apr. 29, 2022.

(30) Foreign Application Priority Data
May 11, 2021 (CN) 202110514932.8

(51) Int. Cl. H04L 9/32; H04L 9/00

(52) U.S. Cl. CPC H04L 9/3268; H04L 9/50

(57) ABSTRACT

A blockchain application method and apparatus. The method comprises: acquiring identity information, CA certificate information and a corporate number of a first corporate user, and performing authentication; matching and binding the authenticated identity information and the authenticated CA certificate information with the corporate number, and generating a corporate number and corporate code in a form of two-dimensional code according to the corporate number; generating an electronic official seal according to the authenticated identity information and the authenticated CA certificate information; when a blockchain application is executed between the first corporate user and a second corporate user, generating a blockchain electronic document according to the electronic seal and specific authenticated CA certificate information; linking the blockchain electronic document with a blockchain approval flow; and querying the blockchain electronic document and the blockchain approval flow by using the specific authenticated CA certificate information, the corporate number and the electronic document number.

### CROSS-REFERENCE TO RELATED APPLICATIONS

This application is a continuation of International Patent Application No. PCT/CN2022/090239 with a filing date of Apr. 29, 2022, designating the United States, now pending, and further claims priority to Chinese Patent Application No. 202110514932.8 with a filing date of May 11, 2021. The content of the aforementioned applications, including any intervening amendments thereto, are incorporated herein by reference.

### TECHNICAL FIELD

The present invention relates to the technical field of information security, and in particular, to a blockchain application method and a blockchain application terminal apparatus.

### BACKGROUND OF THE PRESENT INVENTION

Blockchain refers to a distributed management technology through decentralization and trust removal (such as third-party authentication), so that each node participating in the blockchain generates a Hash value after encrypting data generated in a period of time through a cryptographic algorithm, records the data in a distributed data block (Block), and can link the data to next data block. This distributed management mechanism forms a decentralized public ledger, which can ensure that a content thereof cannot be tampered with.

One of the most promising applications of the blockchain technology is intelligent contract (that is, blockchain contract signing). Once certain conditions are met, the intelligent contract can automatically execute some transactions in the contract without external input from a third party. In addition, the blockchain may also be applied in other different fields, such as blockchain invoicing and blockchain bookkeeping. However, the current blockchain applications are all independent, and there is no platform, device or method to collect and supervise different types of blockchain electronic documents, which is very inconvenient for users.

Therefore, it is urgent for those skilled in the art to develop a method that can further expand blockchain applications on the basis of the original application of “corporate number and corporate code”, and can collect and manage different types of blockchain electronic documents (such as blockchain contracts, blockchain invoices, blockchain transaction records, etc.) to achieve consistency.

It should be noted that the above description of the background is merely illustrative of a clear and complete description of the technical solutions of the present invention, and is convenient for those skilled in the art to understand. The foregoing technical solutions cannot be considered as well known to those skilled in the art because these solutions are set forth in the background section of the present invention.

### SUMMARY OF THE PRESENT INVENTION

In order to overcome the defects in the prior art, the embodiments of the present invention provide a blockchain application method and a blockchain application terminal apparatus.

The embodiments of the present application disclose a blockchain application method, comprising the following steps of: acquiring a plurality of identity information of a first corporate user, and acquiring a plurality of CA certificate information and a corporate number of the first corporate user; performing entity or digital authentication on the plurality of identity information and the plurality of CA certificate information to generate a plurality of authenticated identity information and a plurality of authenticated CA certificate information; matching and binding the plurality of authenticated identity information and the plurality of authenticated CA certificate information with the corporate number of the first corporate user, and generating a corporate number and corporate code in a form of a two-dimensional code according to the corporate number of the first corporate user; generating an electronic official seal according to the plurality of authenticated identity information and the plurality of authenticated CA certificate information; when a blockchain application is executed between the first corporate user and a second corporate user, generating a blockchain electronic document according to the electronic seal and one specific authenticated CA certificate information in the plurality of authenticated CA certificate information, wherein the blockchain electronic document comprises an electronic document number; linking the blockchain electronic document with a blockchain approval flow; and querying the blockchain electronic document and the blockchain approval flow by using the specific authenticated CA certificate information, the corporate number of the first corporate user and the electronic document number.

Further, the method further comprises: establishing a correlation between the blockchain electronic document and a blockchain approval process, and generating a link datum according to the correlation; and linking the blockchain electronic document with the blockchain approval flow according to the link datum.

Further, the blockchain application comprises blockchain contract signing, the blockchain electronic document comprises a blockchain contract, and the electronic document number comprises a contract number, wherein the contract number consists of the corporate number, a contract signing date and a contract serial number.

Further, the blockchain approval flow comprises a plurality of derived blockchain contracts, the plurality of derived blockchain contracts are derived from the blockchain contract and signed by the second corporate user and/or other corporate users.

Further, the blockchain application further comprises blockchain bill payment, the blockchain electronic document comprises a blockchain invoice, and the electronic document number comprises an invoice number, wherein the invoice number consists of the corporate number, an invoicing date and an invoice serial number.

Further, the blockchain approval flow comprises a plurality of derived blockchain invoices, the plurality of derived blockchain invoices are derived from the blockchain invoice and issued by the second corporate user and/or other corporate users.

Further, the blockchain application comprises blockchain bookkeeping, the blockchain electronic document comprises a blockchain transaction record, and the electronic document number comprises a transaction number, wherein the transaction number consists of the corporate number, a transaction record date and a transaction serial number.

Further, the blockchain approval flow comprises a plurality of derived blockchain transaction records, the plurality of derived blockchain transaction records are derived from the blockchain transaction record and completed by the second corporate user and/or other corporate users.

Further, the method further comprises: providing a central control module, and a communication module, an identity authentication module, a key module and a storage module connected with the central control module; using the communication module to realize communication between the first corporate user and an external server; using the identity authentication module to authenticate biometric data input by the first corporate user and authorize the first corporate user after passing the authentication; using the key module to store a plurality of keys, and encrypt the plurality of authenticated identity information and the plurality of authenticated CA certificate information according to corresponding keys in the plurality of keys to generate a plurality of encrypted authenticated identity information and a plurality of encrypted authenticated CA certificate information; using the storage module to store the registered biometric data of the first corporate user, the plurality of encrypted authenticated identity information, the plurality of encrypted authenticated CA certificate information, the corporate number, the electronic official seal, the electronic document number, the blockchain electronic document and the blockchain approval flow; and using the central control module to receive, input and control operations of other modules, and after the first corporate user is authorized, allow the first corporate user to generate the blockchain electronic document according to the electronic official seal and the specific authenticated CA certificate information, and allow the first corporate user to query the blockchain electronic document and the blockchain approval flow by using the specific authenticated CA certificate information, the corporate number of the first corporate user and the electronic document number.

Further, the corporate number comprises a digital corporate name, a mailbox number, a payment number, a cloud number, a video number and/or a fixed telephone number, and the corporate number is internationally common and encoded according to telephone area code encoding rules.

The embodiments of the present application further disclose a blockchain application terminal apparatus, comprising: a first capture module, a second capture module, an information authentication module, a corporate number and corporate code generation module, an electronic official seal generation module, a blockchain electronic document generation module, a linking module and a query module. The first capture module is used for acquiring a plurality of identity information of a first corporate user. The second capture module is used for acquiring a plurality of CA certificate information and a corporate number of the first corporate user. The information authentication module is used for performing entity or digital authentication on the plurality of identity information and the plurality of CA certificate information to generate a plurality of authenticated identity information and a plurality of authenticated CA certificate information. The corporate number and corporate code generation module is used for matching and binding the plurality of authenticated identity information and the plurality of authenticated CA certificate information with the corporate number of the first corporate user, and generating a corporate number and corporate code in a form of a two-dimensional code according to the corporate number of the first corporate user. The electronic official seal generation module is used for generating an electronic official seal according to the plurality of authenticated identity information and the plurality of authenticated CA certificate information. The blockchain electronic document generation module is used for, when a blockchain application is executed between the first corporate user and a second corporate user, generating a blockchain electronic document according to the electronic seal and specific authenticated CA certificate information, wherein the blockchain electronic document comprises an electronic document number. The linking module is used for linking the blockchain electronic document with the blockchain approval flow. The query module is used for querying the blockchain electronic document and the blockchain approval flow by using the specific authenticated CA certificate information, the corporate number of the first corporate user and the electronic document number.

Further, the blockchain application comprises blockchain contract signing, the blockchain electronic document comprises a blockchain contract, and the electronic document number comprises a contract number, wherein the contract number consists of the corporate number, a contract signing date and a contract serial number.

Further, the blockchain application further comprises blockchain bill payment, the blockchain electronic document comprises a blockchain invoice, and the electronic document number comprises an invoice number, wherein the invoice number consists of the corporate number, an invoicing date and an invoice serial number.

Further, the blockchain application comprises blockchain bookkeeping, the blockchain electronic document comprises a blockchain transaction record, and the electronic document number comprises a transaction number, wherein the transaction number consists of the corporate number, a transaction record date and a transaction serial number.

Further, the blockchain application terminal apparatus further comprises: a central control module and a communication module, an identity authentication module, a key module and a storage module connected with the central control module. The communication module is used for realizing communication between the first corporate user and an external server. The identity authentication module is used for authenticating biometric data input by the first corporate user and authorizing the first corporate user after passing the authentication. The key module is used for storing a plurality of keys, and encrypting the plurality of authenticated identity information and the plurality of authenticated CA certificate information according to corresponding keys in the plurality of keys to generate a plurality of encrypted authenticated identity information and a plurality of encrypted authenticated CA certificate information. The storage module is used for storing the registered biometric data of the first corporate user, the plurality of encrypted authenticated identity information, the plurality of encrypted authenticated CA certificate information, the corporate number, the electronic official seal, the electronic document number, the blockchain electronic document and the blockchain approval flow. The central control module is used for receiving, inputting and controlling operations of other modules, and after the first corporate user is authorized, allowing the first corporate user to generate the blockchain electronic document according to the electronic official seal and the specific authenticated CA certificate information, and allowing the first corporate user to query the blockchain electronic document and the blockchain approval flow by using the specific authenticated CA certificate information, the corporate number of the first corporate user and the electronic document number.

By means of the above technical solutions, the beneficial effects of the invention are as follows: compared with the prior art, the blockchain application method and the blockchain application terminal apparatus provided by the present invention further expand the blockchain applications, such as the blockchain contract signing, the blockchain invoicing, the blockchain bookkeeping and the like, on the basis of the application of the original “corporate number and corporate code”. In addition, since the blockchain electronic document BCD has been linked with the blockchain approval flow BCAF, as long as a specific CA certificate number, a corporate number CN and an electronic document number DN of a corporate user A are input, the blockchain electronic document BCD and this series of blockchain approval flow BCAF (such as a derived blockchain contract, a derived blockchain invoice and a derived blockchain transaction record) can be queried at the same time. Moreover, the blockchain contract, the blockchain invoice and the blockchain transaction record are all sent to an electronic mailbox of the corporate user for collection and management. The blockchain contract, the blockchain bookkeeping and the blockchain invoice constitute an economic transaction column, completing the takeover of the blockchain contract and realizing the consistency, correlation, real-time supervision and collection of banks, industry and commerce and taxation.

### DESCRIPTION OF THE DRAWINGS

FIG. 1 is a frame diagram of a blockchain application terminal apparatus in an embodiment of the present invention.

FIG. 2 is a frame diagram of a multi-module in FIG. 1.

FIG. 3 is a schematic diagram of authenticated CA certificate information, corporate number and electronic official seal.

FIG. 4 is a schematic diagram of a blockchain contract and a blockchain approval flow.

FIG. 5 is a flow chart of a blockchain application method in a first embodiment of the present invention.

FIG. 6 is a flow chart of a blockchain application method in a second embodiment of the present invention.

Reference numerals of the above drawings:

10 refers to blockchain application terminal apparatus; 110 refers to first capture module; 120 refers to second capture module; 130 refers to information authentication module; 140 refers to corporate number and corporate code generation module; 150 refers to electronic official seal generation module; 160 refers to blockchain electronic document generation module; 170 refers to linking module; 180 refers to query module; 200 refers to multi-module; 210 refers to central control module; 220 refers to communication module; 230 refers to identity authentication module; 240 refers to key module; 250 refers to storage module; ID1-IDn refers to identity information; aID1-aIDn refers to authenticated identity information; CAI1-CAIm refers to CA certificate information; aCAI1-aCAIm refers to authenticated CA certificate information; CN refers to corporate number; CC Code refers to corporate number and corporate code; ECS refers to electronic official seal; BCD refers to blockchain electronic document; DN refers to electronic document number; BCAF refers to blockchain approval flow; and S510-S570 and S610-S660 refer to steps.

### DETAILED DESCRIPTION OF PREFERRED EMBODIMENTS

To make the above and other objects, features and advantages of the present invention more obvious and easier to understand, the preferred embodiments will be described in detail below in conjunction with the attached drawings.

In order to illustrate the technical solutions in the embodiments of the present invention or in the related art more clearly, the drawings used in the description of the embodiments or the prior art will be briefly described below. Obviously, the drawings in the following description are merely some embodiments recorded in the present invention. For those of ordinary skills in the art, other drawings may also be obtained based on these drawings without going through any creative work.

The following clearly and completely describes the technical solutions in the embodiments of the present invention with reference to the drawings in the embodiments of the present invention. Apparently, the described embodiments are merely some but not all of the embodiments of the present invention. Based on the embodiments of the present invention, all other embodiments obtained by those of ordinary skills in the art without going through any creative work shall fall within the protection scope of the present invention.

It should be noted that in the description of the present invention, the terms “first” and “second” are used for descriptive purposes and distinguish similar objects only, and there is no sequence between the two, nor can it be understood as indicating or implying relative importance. In addition, in the description of the present invention, the meaning of “multiple” is two or more than two, unless otherwise specifically defined.

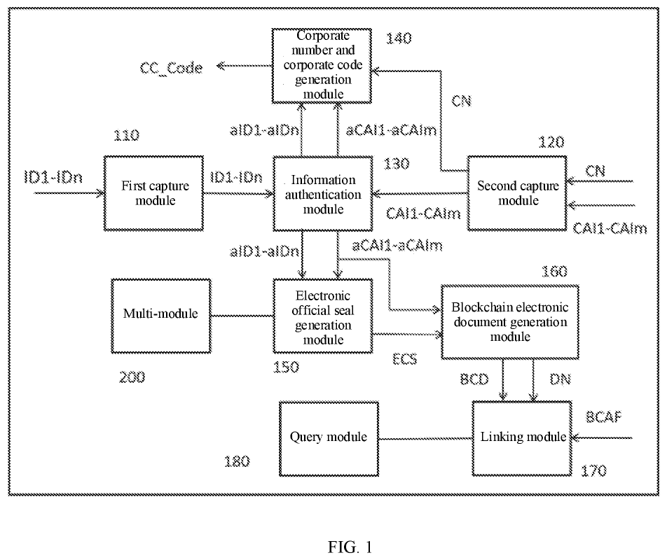

Referring to FIG. 1, FIG. 1 is a frame diagram of a blockchain application terminal apparatus 10 in an embodiment of the present invention. As shown in FIG. 1, the blockchain application terminal apparatus 10 comprises a first capture module 110, a second capture module 120, an information authentication module 130, a corporate number and corporate code generation module 140, an electronic official seal generation module 150, a blockchain electronic document generation module 160, a linking module 170 and a query module 180. The first capture module 110 is used for acquiring a plurality of identity information ID1-IDn of a first corporate user. The second capture module 120 is used for acquiring a plurality of CA (Certificate Authority) certificate information CAI1-CAIm and a corporate number CN of the first corporate user. The information authentication module 130 coupled to the first capture module 110 and the second capture module 120, and used for performing entity or digital authentication on the plurality of identity information ID1-IDn and the plurality of CA certificate information CAI1-CAIm to generate a plurality of authenticated identity information aID1-aIDn and a plurality of authenticated CA certificate information aCAI1-aCAIm. The corporate number and corporate code generation module 140 is coupled to the information authentication module 130 and the second capture module 120, and used for matching and binding the plurality of authenticated identity information aID1-aIDn and the plurality of authenticated CA certificate information aCAI1-aCAIm with the corporate number CN of the first corporate user, and generating a corporate number and corporate code CC Code in a form of a two-dimensional code according to the corporate number CN of the first corporate user. The electronic official seal generation module 150 is coupled to the information authentication module 130, and used for generating an electronic official seal ECS according to the plurality of authenticated identity information aID1-aIDn and the plurality of authenticated CA certificate information aCAI1-aCAIm. The blockchain electronic document generation module 160 is coupled to the information authentication module 130 and the electronic official seal generation module 150, and used for, when a blockchain application is executed between the first corporate user (such as corporate user A) and a second corporate user (such as corporate user B), generating a blockchain electronic document BCD according to the electronic seal ECS and one specific authenticated CA certificate information in the plurality of authenticated CA certificate information aCAI1-aCAIm, wherein the blockchain electronic document BCD comprises an electronic document number DN. The linking module 170 is coupled to the blockchain electronic document generation module 160, and used for linking the blockchain electronic document BCD with the blockchain approval flow (Blockchain Approval Flow) BCAF. The query module 180 is coupled to the linking module 170, and used for querying the blockchain electronic document BCD and the blockchain approval flow BCAF by using the specific authenticated CA certificate information, the corporate number CN of the first corporate user and the electronic document number DN.

Please note that the plurality of identity information ID1-IDn may comprise an ID card, an address, a mailbox number, a telephone number and/or a video number of a company founder (i.e., the corporate user), but the present invention is not limited to this.

Please note that the corporate number CN may comprise a digital corporate name, a mailbox number, a payment number, a cloud number, a video number and/or fixed telephone number, but the present invention is not limited to this. The corporate number CN may not only be domestically common, but also internationally common, and encoded according to telephone area code encoding rules. In other words, any number and code (comprising seal and key authentication) of the first corporate user can be accessed. In practice, whether the number and code are accessed or not may be decided by the examination and approval authority of the corporate or a competent department.

In an embodiment, after completing the entity or digital authentication on the plurality of identity information ID1-IDn and the plurality of CA certificate information CAI1-CAIm, the information authentication module 130 may send a digital protocol to the corresponding external server, and then generate the plurality of authenticated identity information alD1-aIDn and the plurality of authenticated CA certificate information aCAI1-aCAIm. Next, the corporate number and corporate code generation module 140 may first verify whether the plurality of authenticated CA certificate information aCAI1-aCAIm of the company founder of the corporate user and the plurality of authenticated CA certificate information aCAI1-aCAIm are matched with the corporate number CN of the corporate user. When the matching is successful, the corporate number and corporate code generation module 140 may generate the corporate number and corporate code CC Code in the form of two-dimensional code according to the corporate number CN of the first corporate user. In this way, the corporate user successfully registers the company on the blockchain application terminal apparatus 10. In this case, the first corporate user can not only generate the corporate number and corporate code CC Code in the form of two-dimensional code, but also has the electronic official seal ECS, the CA certificate information and the electronic mailbox of the corporate, and automatically completes the registration of the legal person electronic personal seal.

In an embodiment, the linking module 170 may establish a correlation between the blockchain electronic document BCD and the blockchain approval flow BCAF first, and generate a link datum according to the correlation of the two, and then link the BCD with the blockchain approval flow BCAF according to the link datum. After the linking module 170 links the blockchain electronic document BCD with the blockchain approval flow BCAF, the query module 180 can query not only the blockchain electronic document BCD, but also the blockchain approval flow BCAF by inputting information such as the specific authenticated CA certificate information, the corporate number CN of the first corporate user and the electronic document number DN.

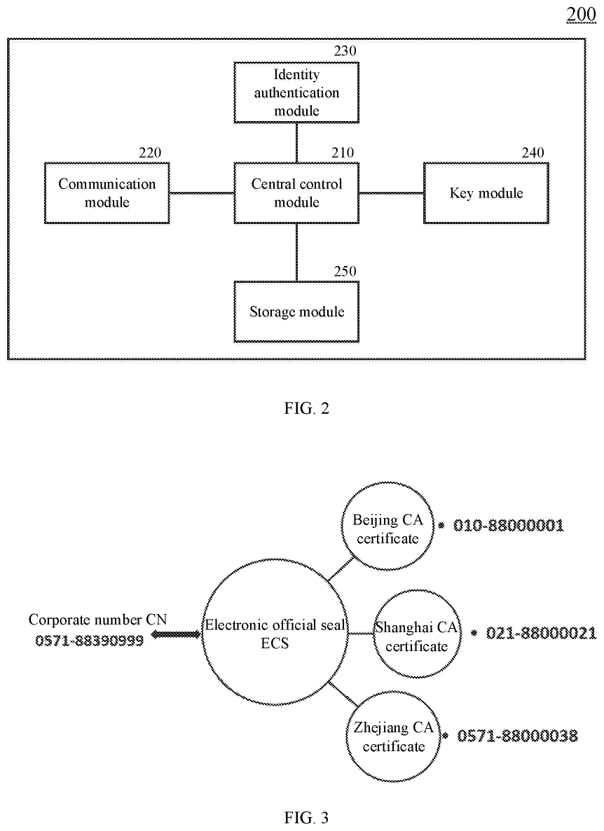

Referring to FIG. 1 and FIG. 2, the blockchain application terminal apparatus 10 further comprises a multi-module 200. As shown in FIG. 2, the multi-module 200 comprises a central control module 210, and a communication module 220, an identity authentication module 230, a key module 240 and a storage module 250 connected with the central control module 210. The communication module 220 is used for realizing communication between the first corporate user (such as corporate user A) and an external server. The identity authentication module 230 is used for authenticating biometric data input by the first corporate user and authorizing the first corporate user after passing the authentication. The key module 240 is used for storing a plurality of keys, and encrypting the plurality of authenticated identity information aID1-aIDn and the plurality of authenticated CA certificate information aCAI1-aCAIm according to corresponding keys in the plurality of keys to generate a plurality of encrypted authenticated identity information eaID1-eaIDn and a plurality of encrypted authenticated CA certificate information eaCAI1-eaCAIm. The storage module 250 is used for storing the registered biometric data of the first corporate user, the plurality of encrypted authenticated identity information eaID1-eaIDn, the plurality of encrypted authenticated CA certificate information eaCAI1-eaCAlm, the corporate number CN, the electronic official seal ECS, the electronic document number DN, the blockchain electronic document BCD and the blockchain approval flow BCAF. The central control module 210 is used for receiving, inputting and controlling operations of other modules 220-250, and after the first corporate user is authorized, allowing the first corporate user to generate the blockchain electronic document BCD according to the electronic official seal ECS and the specific authenticated CA certificate information, and allowing the first corporate user to query the blockchain electronic document BCD and the blockchain approval flow BCAF by using the specific authenticated CA certificate information, the corporate number CN of the first corporate user and the electronic document number DN.

Further, the communication module 220 may comprise: at least one of a 3G communication module, a 4G communication module, a 5G communication module, a WIFI module, an NBIoT module, a Bluetooth module, an NFC module and an infrared module. The communication module 220 supports IPV4 and IPV6 protocols.

Please note that the above biometric data may comprise fingerprint information data, iris information data and/or facial feature recognition data, or any biometric data that can identify users. In practical application, one or more of the data may be used for security identification.

The blockchain application terminal apparatus of the present invention may be a trusted authentication server system or a third-party authentication platform system. This terminal apparatus comprises authentication, storage, management and application of various certificate keys such as electronic seals, and the terminal apparatus corresponds to any department or platform system of social transactions, comprising government, corporate and individual families.

The blockchain application terminal apparatus of the present invention can be realized by a physical-electronic integrated intelligent electronic seal chip. The physical-electronic integrated intelligent electronic seal chip stores various certificates and keys, and all the certificates and keys can be distributed, downloaded, stored and applied remotely.

Referring to FIG. 3, FIG. 3 is a schematic diagram of authenticated CA certificate information, a corporate number and an electronic official seal. Please note that a CA certificate of each territory is a CA certificate given with a certificate number in the form of a telephone number with area code according to the territory, and the CA certificate may be bound with a corresponding CA key certificate, while authenticated CA certificate information may be generated for the CA certificate number and the corresponding CA key certificate, i.e., the CA certificate information in the present invention after passing the entity or digital authentication. For example, as shown in FIG. 3, a CA certificate number of Beijing CA certificate is 010-88000001, a CA certificate number of Shanghai CA certificate is 021-88000021, and a CA certificate number of Zhejiang CA certificate is 0571-88000038. The electronic official seal ECS is generated according to the plurality of authenticated identity information aID1-aIDn and the plurality of authenticated CA certificate information aCAI1-aCAIm, in other words, the electronic official seal ECS further comprises the plurality of authenticated CA certificate information aCAI1-aCAIm. The plurality of authenticated identity information aID1-aIDn and the plurality of authenticated CA certificate information aCAI1-aCAIm may be matched and bound with the corporate number CN, that is, the CA certificate information is associated with the corporate number CN, the CA certificate information can be queried, and all blockchain electronic documents (such as a blockchain contract, a blockchain invoice and a blockchain transaction record) concluded with the CA certificate information can be queried through the CA certificate number. For example, in FIG. 3, a corporate number CN of Xixin Technology Company is 0571-88390999, and an electronic official seal ECS thereof comprises authenticated CA certificate information of Beijing CA certificate, Shanghai CA certificate and Zhejiang CA certificate. In a practical application scenario of the electronic official seal, each authenticated CA certificate information can be seen by clicking in an electronic official seal APP (comprising readers and various corresponding application query systems).

Please note that, generally speaking, the plurality of authenticated CA certificate information aCAI1-aCAIm are encrypted according to the corresponding keys to generate a plurality of encrypted authenticated CA certificate information eaCAI1-eaCAIm, while in the blockchain application, a time stamp may be added for encryption, which is called “CA key certificate chain”. In addition, the authenticated CA certificate information eaCAI1-eaCAIm of the present invention may also be bound with an IP address of a corporate server (for example, an IP address conforming to the IPV6 protocol). The blockchain of the present invention is expanded on the basis of the corporate number and corporate code CC Code, which may also be called “corporate number and corporate code blockchain”. In other words, any application of the corporate user (comprising blockchain applications) is replaced by numbers, comprising the electronic official seal, the CA certificate information, the blockchain contract, the blockchain invoice, the blockchain transaction record, and the like.

In a first embodiment, the above-mentioned blockchain application may comprise blockchain contract signing, the blockchain electronic document BCD may comprise a blockchain contract, and the electronic document number DN comprises a contract number, wherein the contract number consists of a corporate number CN, a contract signing date and a contract serial number. The contract signing date is the date when the corporate user A and the corporate user B sign the blockchain contract. The contract signing date may be an eight-digit date or a six-digit date. For example, May 2, 2021 may be represented by “20210502” or “210502”. The blockchain contract may or may not have verification codes, which may be set according to actual needs. For example, commodity transaction (trading) may be regarded as a factual contract, and the transaction day is the contract signing date. The number of digits of the contract serial number is not limited and may be determined according to the actual needs of each corporate. For example, Xixin Technology Company signed a blockchain contract with the corporate user B on May 2, 2021, and the contract number thereof may be 0571-88390999-20210502-000001.

In a second embodiment, the above-mentioned blockchain application may comprise blockchain bill payment, the blockchain electronic document BCD may comprise a blockchain invoice, and the electronic document number DN comprises an invoice number, wherein the invoice number consists of the corporate number CN, an invoicing date and an invoice serial number. The invoicing date is the date when the corporate user A issues the blockchain invoice to the corporate user B. The invoicing date may be an eight-digit date or a six-digit date. For example, May 2, 2021 may be represented by “20210502” or “210502”. The blockchain invoice may or may not have verification codes, which may be set according to actual needs. The number of digits of the invoice serial number is not limited and may be determined according to the actual needs of each corporate. For example, Xixin Technology Company issued a blockchain invoice to the corporate user B on May 2, 2021, and the invoice number thereof may be 0571-88390999-20210502-0000021.

In a third embodiment, the above-mentioned blockchain application may comprise blockchain bookkeeping, the blockchain electronic document BCD may comprise a blockchain transaction record, and the electronic document number DN comprises a transaction number, wherein the transaction number consists of a corporate number CN, a transaction record date and a transaction serial number. The transaction record date is the date of the blockchain transaction between the corporate user A and the corporate user B. The transaction record date may be an eight-digit date or a six-digit date. For example, May 2, 2021 may be represented by “20210502” or “210502”. The blockchain transaction record may or may not have verification codes, which may be set according to actual needs. The number of digits of the transaction serial number is not limited and may be determined according to the actual needs of each corporate. For example, Xixin Technology Company conducted a blockchain transaction with the corporate user B on May 2, 2021, and the transaction number thereof may be 0571-88390999-20210502-000000345.

It is worth noting that there may be one or more blockchain invoices corresponding to one blockchain contract. Similarly, for one blockchain invoice, there may also be one or more blockchain transaction records. In this way, according to the “contract number” and the “invoice number”, collection management and bank reconciliation management of the blockchain contract, the blockchain invoice and the blockchain transaction record can be carried out. After that, the blockchain contract, the blockchain invoice and the blockchain transaction record are all sent to an electronic mailbox of the corporate user for collection and management. The blockchain contract, the blockchain bookkeeping and the blockchain invoice constitute an economic transaction column, completing the takeover of the blockchain contract and realizing the consistency, correlation, real-time supervision and collection of banks, industry and commerce and taxation.

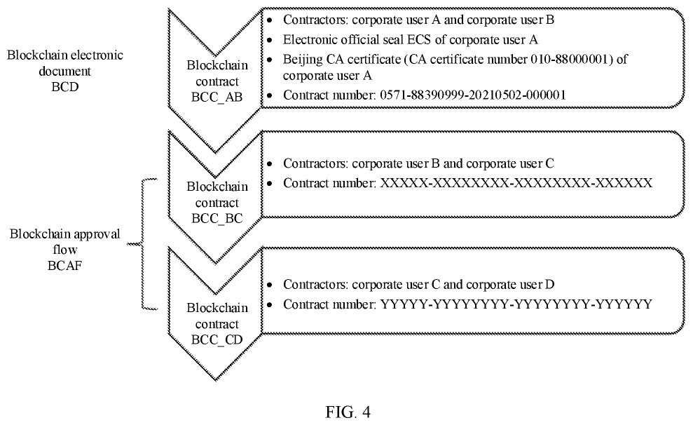

Referring to FIG. 4, FIG. 4 is a schematic diagram of the blockchain contract and the blockchain approval flow. Following the first embodiment, the blockchain application comprises blockchain contract signing, and the blockchain electronic document BCD comprises blockchain contract, then the afore-mentioned blockchain approval flow BCAF may comprise a plurality of derived blockchain contracts, the plurality of derived blockchain contracts are derived from the blockchain contract and signed by the second corporate user (such as corporate user B) and/or other corporate users (such as corporate user C and corporate user D). For example, in FIG. 4, in the same series of blockchain contract signing flow, the corporate user A (for example, Xixin Technology Company) may sign a blockchain contract BCC_AB with the corporate user B using the electronic official seal ECS and Beijing CA certificate (CA certificate number is 010-88000001), while the corporate user B signs a blockchain contract BCC BC with the corporate user C. Then, the corporate user C signs a blockchain contract BCC CD with the corporate user D. In other words, the blockchain contract BCC BC and the blockchain contract BCC CD are derived from the blockchain contract BCC_AB and form the blockchain approval flow BCAF. After that, the linking module 170 may link the blockchain contract BCC_AB with the blockchain approval flow BCAF (i.e., the blockchain contract BCC BC and the blockchain contract BCC CD), so that as long as the CA certificate number of Beijing CA certificate (e.g., 010-88000001) and corporate number CN (e.g., 0571-88390999) of Xixin Technology Company and the contract number (for example, 0571-88390999-20210502-000001) of the blockchain contract BCC_AB, not only the blockchain contract BCC_AB can be queried, but also this series of blockchain approval flow BCAF (i.e., the blockchain contract BCC BC, and the blockchain contract BCC CD) can be further queried.

Please note that although the present invention can query the blockchain contract BCC_AB and this series of blockchain approval flow BCAF (i.e., the blockchain contract BCC BC and the blockchain contract BCC CD), core contents of the blockchain contract BCC BC and the blockchain contract BCC CD can only be seen by the corporate user A after being granted permissions by the corporate user B, the corporate user C and the corporate user D; otherwise, the corporate user A can only see basic information such as contract signers, the contract numbers and the contract signing dates of the blockchain contract BCC BC and the blockchain contract BCC CD.

Following the second embodiment, the blockchain application comprises blockchain invoicing, and the blockchain electronic document BCD comprises a blockchain invoice, then the afore-mentioned blockchain approval flow BCAF may comprise a plurality of derived blockchain invoices, the plurality of derived blockchain invoices are derived from the blockchain invoice and signed by the second corporate user (such as corporate user B) and/or other corporate users (such as corporate user C and corporate user D). For example, in the same series of blockchain invoicing flows, the corporate user A (for example, Xixin Technology Company) may use the electronic official seal ECS and Shanghai CA certificate (CA certificate number is 021-88000021) to issue a blockchain invoice BCI_AB to the corporate user B, while the corporate user B may issue a blockchain invoice BCI_BC to the corporate user C. Then, the corporate user C may issue a blockchain invoice BCI_CD to the corporate user D. In other words, the blockchain invoice BCI_BC and the blockchain invoice BCI_CD are derived from the blockchain invoice BCI_AB and form the blockchain approval flow BCAF. After that, the linking module 170 may link the blockchain invoice BCI_AB with the blockchain approval flow BCAF (i.e., the blockchain invoice BCI_BC and the blockchain invoice BCI_CD), so that as long as the CA certificate number of Shanghai CA certificate (e.g., 021-88000021) and corporate number CN (e.g., 0571-88390999) of Xixin Technology Company and the contract number (for example, 0571-88390999-20210502-00000021) of the blockchain invoice BCI_AB, not only the blockchain invoice BCI_AB can be queried, but also this series of blockchain approval flow BCAF (i.e., the blockchain invoice BCI_BC, and the blockchain invoice BCI_CD) can be further queried.

Following the third embodiment, the blockchain application comprises blockchain bookkeeping, and the blockchain electronic document BCD comprises a blockchain transaction record, then the afore-mentioned blockchain approval flow BCAF may comprise a plurality of derived blockchain transaction records, the plurality of derived blockchain transaction records are derived from the blockchain transaction record and signed by the second corporate user (such as corporate user B) and/or other corporate users (such as corporate user C and corporate user D). For example, in the same series of blockchain accounting flows, the corporate user A (such as Xixin Technology Company) may use the electronic official seal ECS and Zhejiang CA certificate (CA certificate number is 0571-88000038) to conduct a blockchain transaction BCT_AB with the corporate user B, while the corporate user B conducts a blockchain transaction BCT_BC with the corporate user C. Then, the corporate user C conducts a blockchain transaction BCT_CD with the corporate user D. In other words, the blockchain transaction BCT_BC and the blockchain transaction BCT_CD are derived from the blockchain transaction BCT_AB and form the blockchain approval flow BCAF. After that, the linking module 170 may link the blockchain transaction BCT_AB with the blockchain approval flow BCAF (i.e., the blockchain transaction BCT_BC and the blockchain transaction BCT_CD), so that as long as the CA certificate number (e.g., 0571-88000038) of zhejiang CA certificate and corporate number CN (e.g., 0571-88390999) of Xixin Technology Company and the transaction number (for example, 0571-88390999-20210502-000000345) of the blockchain transaction BCT_AB, not only the blockchain transaction BCT_AB can be queried, but also this series of blockchain approval flow BCAF (that is, the blockchain transaction BCT_BC and the blockchain transaction BCT_CD) can be further queried.

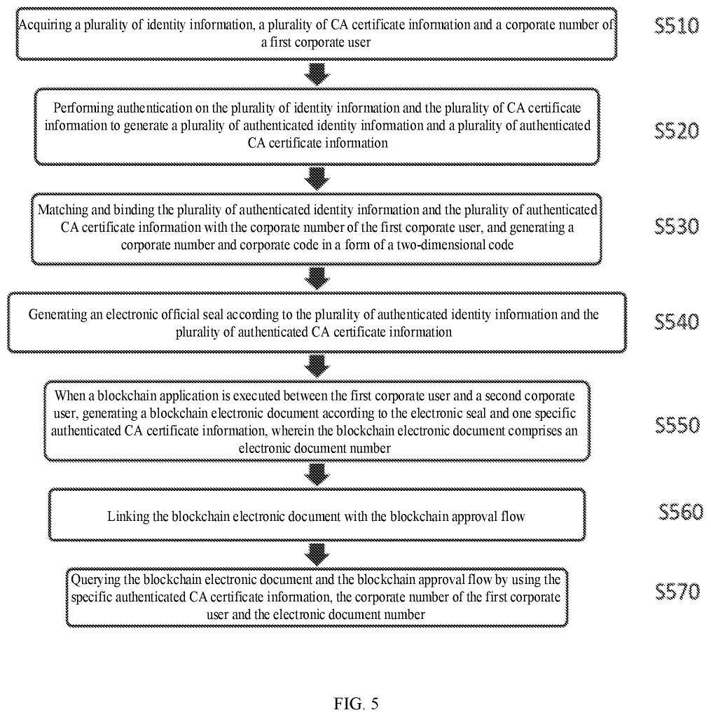

Referring to FIG. 1 and FIG. 5, FIG. 5 is a flow chart of a blockchain application method in a first embodiment of the present invention. The blockchain application method in FIG. 5 comprises the following steps of:

acquiring a plurality of identity information of a first corporate user, and acquiring a plurality of CA certificate information and a corporate number of the first corporate user.

Step S520: performing entity or digital authentication on the plurality of identity information and the plurality of CA certificate information to generate a plurality of authenticated identity information and a plurality of authenticated CA certificate information.

Step S530: matching and binding the plurality of authenticated identity information and the plurality of authenticated CA certificate information with the corporate number of the first corporate user, and generating a corporate number and corporate code in a form of a two-dimensional code according to the corporate number of the first corporate user.

Step S540: generating an electronic official seal according to the plurality of authenticated identity information and the plurality of authenticated CA certificate information.

Step S550: when a blockchain application is executed between the first corporate user and a second corporate user, generating a blockchain electronic document according to the electronic seal and one specific authenticated CA certificate information in the plurality of authenticated CA certificate information, wherein the blockchain electronic document comprises an electronic document number.

Step S560: linking the blockchain electronic document with the blockchain approval flow.

Step S570: querying the blockchain electronic document and the blockchain approval flow by using the specific authenticated CA certificate information, the corporate number of the first corporate user and the electronic document number.

It should be noted that the step S510 is performed by the first capture module 110 and the second capture module 120, the step S520 is performed by the information authentication module 130, the step S530 is performed by the corporate number and corporate code generation module 140, the step S540 is executed by the electronic official seal generation module 150, the step S550 is executed by the blockchain electronic document generation module 160, the step S560 is executed by the linking module 170, and the step S570 is executed by the query module 180.

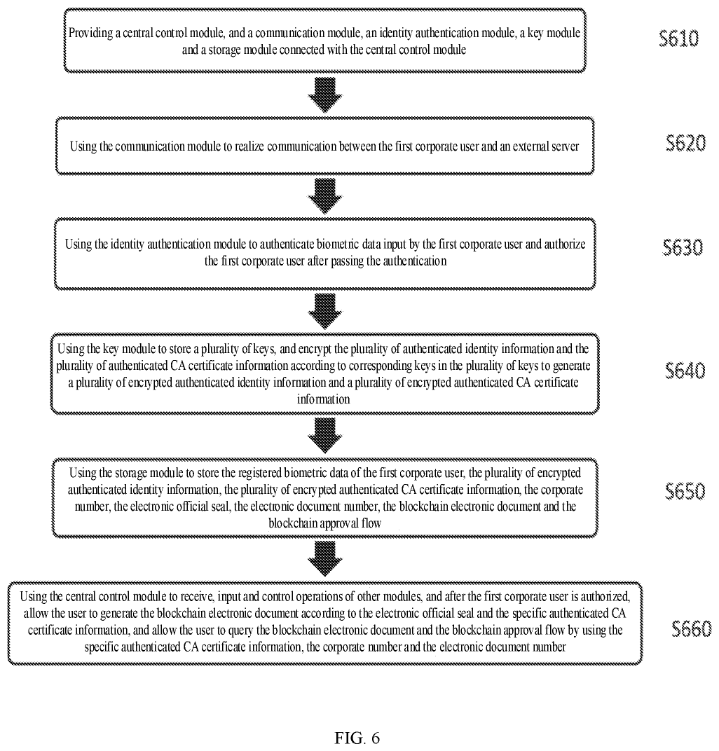

Referring to FIG. 2 and FIG. 6, FIG. 6 is a flow chart of a blockchain application method in a second embodiment of the present invention. The blockchain application method in FIG. 6 comprises the following steps of:

Step S610: providing a central control module, and a communication module, an identity authentication module, a key module and a storage module connected with the central control module.

Step S620: using the communication module to realize communication between the first corporate user and an external server.

Step S630: using the identity authentication module to authenticate biometric data input by the first corporate user and authorize the first corporate user after passing the authentication.

Step S640: using the key module to store a plurality of keys, and encrypt the plurality of authenticated identity information and the plurality of authenticated CA certificate information according to corresponding keys in the plurality of keys to generate a plurality of encrypted authenticated identity information and a plurality of encrypted authenticated CA certificate information.

Step S650: using the storage module to store the registered biometric data of the first corporate user, the plurality of encrypted authenticated identity information, the plurality of encrypted authenticated CA certificate information, the corporate number, the electronic official seal, the electronic document number, the blockchain electronic document and the blockchain approval flow.

Step S660: using the central control module to receive, input and control operations of other modules, and after the first corporate user is authorized, allow the first corporate user to generate the blockchain electronic document according to the electronic official seal and the specific authenticated CA certificate information, and allow the first corporate user to query the blockchain electronic document and the blockchain approval flow by using the specific authenticated CA certificate information, the corporate number of the first corporate user and the electronic document number.

It should be noted that the step S620 is performed by the communication module 220, the step S630 is performed by the identity authentication module 230, the step S640 is performed by the key module 240, the step S650 is performed by the storage module 250, and the step S660 is performed by the central control module 210.

The specific embodiments of the present invention provide the blockchain application method and the blockchain application terminal apparatus, which can further expand the blockchain applications, such as the blockchain contract signing, the blockchain invoicing, the blockchain bookkeeping and the like, on the basis of the application of the original “corporate number and corporate code”. When a blockchain application is executed between a corporate user A and a second corporate user B, a blockchain electronic document BCD (such as blockchain contract, blockchain invoice, blockchain transaction record) can be generated according to an electronic official seal ECS and specific authenticated CA certificate information of the corporate user A; after that, the blockchain electronic document BCD is linked with the blockchain approval flow BCAF. In this way, as long as the specific CA certificate number, the corporate number CN and the electronic document number DN of the corporate user A are input, not only the blockchain electronic document BCD can be queried, but also this series of blockchain approval flow BCAF (such as a derived blockchain contract, a derived blockchain invoice and a derived blockchain transaction record) can be further queried.

The embodiments of the present invention above may be implemented in various hardware, software codes or a combination of the two. For example, the embodiments of the present invention may also execute the program code of the above method in a Digital Signal Processor (DSP). The present invention may also relate to various functions performed by a computer processor, a digital signal processor, a microprocessor or a Field Programmable Gate Array (FPGA). According to the present invention, the above processors can be configured to perform specific tasks, which are accomplished by executing machine-readable software code or firmware code that defines the specific methods disclosed in the present invention. Software code or firmware code may be developed into different programming languages and different formats or forms. Software codes may also be compiled for different target platforms. However, different code styles, types and languages of software codes performing tasks according to the present invention and other types of configuration codes do not depart from the spirit and scope of the present invention.

The blockchain application terminal apparatus of the present invention stores certificates and keys in a physical-electronic integrated intelligent electronic seal chip, rather than in a public platform, so that the privacy is strong and the security is high. Moreover, all the information is saved in a form of electronic keys, and then retrieved and used according to actual needs, which greatly improves the security of the certificates and the keys.

By means of the above technical solutions, the beneficial effects of the invention are as follows: compared with the prior art, the blockchain application method and the blockchain application terminal apparatus provided by the present invention further expand the blockchain applications, such as the blockchain contract signing, the blockchain invoicing, the blockchain bookkeeping and the like, on the basis of the application of the original “corporate number and corporate code”. In addition, since the blockchain electronic document BCD has been linked with the blockchain approval flow BCAF, as long as a specific CA certificate number, a corporate number CN and an electronic document number DN of a corporate user A are input, the blockchain electronic document BCD and this series of blockchain approval flow BCAF (such as a derived blockchain contract, a derived blockchain invoice and a derived blockchain transaction record) can be queried at the same time. Moreover, the blockchain contract, the blockchain invoice and the blockchain transaction record are all sent to an electronic mailbox of the corporate user for collection and management. The blockchain contract, the blockchain bookkeeping and the blockchain invoice constitute an economic transaction column, completing the takeover of the blockchain contract and realizing the consistency, correlation, real-time supervision and collection of banks, industry and commerce and taxation.

Specific examples are used herein to illustrate the principles and embodiments of the present invention. The description of the above embodiments is only used to help understand the methods and core ideas of the present invention. Meanwhile, for those of ordinary skills in the art, there will be changes in the specific implementation and application scope according to the idea of the present invention. To sum up, the contents of this specification should not be understood as limiting the present invention.

We claim:

1. A blockchain application method, wherein the method comprises the following steps of:
acquiring a plurality of identity information of a first corporate user, and acquiring a plurality of CA certificate information and a corporate number of the first corporate user;
performing entity or digital authentication on the plurality of identity information and the plurality of CA certificate information to generate a plurality of authenticated identity information and a plurality of authenticated CA certificate information;
matching and binding the plurality of authenticated identity information and the plurality of authenticated CA certificate information with the corporate number of the first corporate user, and generating a corporate number and corporate code in a form of a two-dimensional code according to the corporate number of the first corporate user;
generating an electronic official seal according to the plurality of authenticated identity information and the plurality of authenticated CA certificate information;
when a blockchain application is executed between the first corporate user and a second corporate user, generating a blockchain electronic document according to the electronic seal and one specific authenticated CA certificate information in the plurality of authenticated CA certificate information, wherein the blockchain electronic document comprises an electronic document number;
establishing a correlation between the blockchain electronic document and a blockchain approval process, and generating a link datum according to the correlation;
linking the blockchain electronic document with the blockchain approval flow according to the link datum, wherein the blockchain approval flow is derived from the blockchain electronic document and signed by the second corporate user and/or other corporate users; and
querying the blockchain electronic document and the blockchain approval flow by using the specific authenticated CA certificate information, the corporate number of the first corporate user and the electronic document number;
the blockchain application comprising blockchain bookkeeping, the blockchain electronic document comprising a blockchain transaction record, and the electronic document number comprising a transaction number, wherein the transaction number consists of the corporate number, a transaction record date and a transaction serial number;
the blockchain application further comprising blockchain contract signing, the blockchain electronic document comprising a blockchain contract, and the electronic document number comprising a contract number, wherein the contract number consists of the corporate number, a contract signing date and a contract serial number; and
the blockchain application further comprising blockchain bill payment, the blockchain electronic document comprising a blockchain invoice, and the electronic document number comprising an invoice number, wherein the invoice number consists of the corporate number, an invoicing date and an invoice serial number.

2. The blockchain application method according to claim 1, further comprising:
providing a central control module, and a communication module, an identity authentication module, a key module and a storage module connected with the central control module;
using the communication module to realize communication between the first corporate user and an external server;
using the identity authentication module to authenticate biometric data input by the first corporate user and authorize the first corporate user after passing the authentication;
using the key module to store a plurality of keys, and encrypt the plurality of authenticated identity information and the plurality of authenticated CA certificate information according to corresponding keys in the plurality of keys to generate a plurality of encrypted authenticated identity information and a plurality of encrypted authenticated CA certificate information;
using the storage module to store the registered biometric data of the first corporate user, the plurality of encrypted authenticated identity information, the plurality of encrypted authenticated CA certificate information, the corporate number, the electronic official seal, the electronic document number, the blockchain electronic document and the blockchain approval flow; and
using the central control module to receive, input and control operations of other modules, and after the first corporate user is authorized, allow the first corporate user to generate the blockchain electronic document according to the electronic official seal and the specific authenticated CA certificate information, and allow the first corporate user to query the blockchain electronic document and the blockchain approval flow by using the specific authenticated CA certificate information, the corporate number of the first corporate user and the electronic document number.

3. The blockchain application method according to claim 1, wherein the corporate number comprises a digital corporate name, a mailbox number, a payment number, a cloud number, a video number and/or a fixed telephone number, and the corporate number is internationally common and encoded according to telephone area code encoding rules.

4. The blockchain application method according to claim 1, wherein the blockchain approval flow comprises a plurality of derived blockchain transaction records, the plurality of derived blockchain transaction records are derived from the blockchain transaction record and completed by the second corporate user and/or other corporate users.

5. The blockchain application method according to claim 1, wherein the blockchain approval flow comprises a plurality of derived blockchain contracts, the plurality of derived blockchain contracts are derived from the blockchain contract and signed by the second corporate user and/or other corporate users.

6. The blockchain application method according to claim 1, wherein the blockchain approval flow comprises a plurality of derived blockchain invoices, the plurality of derived blockchain invoices are derived from the blockchain invoice and issued by the second corporate user and/or other corporate users.

7. A blockchain application terminal apparatus, comprising:
a first capture module, used for acquiring a plurality of identity information of a first corporate user;
a second capture module, used for acquiring a plurality of CA certificate information and a corporate number of the first corporate user;
an information authentication module, coupled to the first capture module and the second capture module and used for performing entity or digital authentication on the plurality of identity information and the plurality of CA certificate information to generate a plurality of authenticated identity information and a plurality of authenticated CA certificate information;
a corporate number and corporate code generation module, coupled to the information authentication module and the second capture module, and used for matching and binding the plurality of authenticated identity information and the plurality of authenticated CA certificate information with the corporate number of the first corporate user, and generating a corporate number and corporate code in a form of a two-dimensional code according to the corporate number of the first corporate user;
an electronic official seal generation module, coupled to the information authentication module and used for generating an electronic official seal according to the plurality of authenticated identity information and the plurality of authenticated CA certificate information;
a blockchain electronic document generation module, coupled to the information authentication module and the electronic official seal generation module, and used for, when a blockchain application is executed between the first corporate user and a second corporate user, generating a blockchain electronic document according to the electronic seal and one specific authenticated CA certificate information in the plurality of authenticated CA certificate information, wherein the blockchain electronic document comprises an electronic document number;
a linking module, coupled to the blockchain electronic document generation module and used for establishing a correlation between the blockchain electronic document and a blockchain approval process, and generating a link datum according to the correlation, and then linking the blockchain electronic document with the blockchain approval flow according to the link datum, wherein the blockchain approval flow is derived from the blockchain electronic document and signed by the second corporate user and/or other corporate users; and
a query module, coupled to the linking module and used for querying the blockchain electronic document and the blockchain approval flow by using the specific authenticated CA certificate information, the corporate number of the first corporate user and the electronic document number;
the blockchain application comprising blockchain contract signing, the blockchain electronic document comprising a blockchain contract, and the electronic document number comprising a contract number, wherein the contract number consists of the corporate number, a contract signing date and a contract serial number;
the blockchain application further comprising blockchain bill payment, the blockchain electronic document comprising a blockchain invoice, and the electronic document number comprising an invoice number, wherein the invoice number consists of the corporate number, an invoicing date and an invoice serial number; and
the blockchain application further comprising blockchain bookkeeping, the blockchain electronic document comprising a blockchain transaction record, and the electronic document number comprising a transaction number, wherein the transaction number consists of the corporate number, a transaction record date and a transaction serial number.

8. The blockchain application terminal apparatus according to claim 7, further comprising a multi-module, wherein the multi-module comprises:
a central control module, and a communication module, an identity authentication module, a key module and a storage module connected with the central control module;
the communication module is used for realizing communication between the first corporate user and an external server;
the identity authentication module is used for authenticating biometric data input by the first corporate user and authorizing the first corporate user after passing the authentication;
the key module is used for storing a plurality of keys, and encrypting the plurality of authenticated identity information and the plurality of authenticated CA certificate information according to corresponding keys in the plurality of keys to generate a plurality of encrypted authenticated identity information and a plurality of encrypted authenticated CA certificate information;
the storage module is used for storing the registered biometric data of the first corporate user, the plurality of encrypted authenticated identity information, the plurality of encrypted authenticated CA certificate information, the corporate number, the electronic official seal, the electronic document number, the blockchain electronic document and the blockchain approval flow; and
the central control module is used for receiving, inputting and controlling operations of other modules, and after the first corporate user is authorized, allowing the first corporate user to generate the blockchain electronic document according to the electronic official seal and the specific authenticated CA certificate information, and allowing the first corporate user to query the blockchain electronic document and the blockchain approval flow by using the specific authenticated CA certificate information, the corporate number of the first corporate user and the electronic document number.
